(19) United States
(12) Patent Application Publication
(10) Pub. No.: US 2007/0184307 A1
(43) Pub. Date: Aug. 9, 2007

(54) Perpendicular magnetic recording media including soft magnetic underlayer with diffusion barrier layer

(75) Inventors: Jae-Cheol Lee, Suwon-si (KR); Seong-yong Yoon, Suwon-si (KR); Hoon-sang Oh, Seongnam-si (KR); Seul-ki Kim, Goyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/701,489

(22) Filed: Feb. 2, 2007

(30) Foreign Application Priority Data
Feb. 9, 2006 (KR) 10-2006-0012597

(51) Int. Cl. G11B 5/66

(52) U.S. Cl. 428/829

(57) ABSTRACT

Provided are perpendicular magnetic recording media including a soft magnetic underlayer with a diffusion barrier layer. The soft magnetic underlayer includes an underlayer, a diffusion barrier layer, and an AFM layer, and a soft magnetic layer.

### CROSS-REFERENCE TO RELATED PATENT APPLICATION

This application claims the benefit of Korean Patent Application No. 10-2006-0012597, filed on Feb. 9, 2006, in the Korean Intellectual Property Office, the disclosure of which is incorporated herein in its entirety by reference.

### BACKGROUND OF THE INVENTION

1. Field of the Invention

The present invention relates to perpendicular magnetic recording media, and more particularly, to perpendicular magnetic recording media including a soft magnetic underlayer which includes a layer blocking diffusion of a magnetic material of the soft magnetic underlayer.

2. Description of the Related Art

As a demand for subminiature recording media increases recently, magnetic recording media having high areal recording density is highly required. Though magnetic recording by a magnetic recording apparatus has been performed using longitudinal magnetic recording in a conventional art, perpendicular magnetic recording has been proposed in order to improve areal recording density. The perpendicular magnetic recording magnetizes a magnetic recording layer in a perpendicular direction to record information. The magnetic recording layer is formed of a magnetic material having high magnetic anisotropy and high coercivity. A conventional perpendicular magnetic recording apparatus will be described with reference to FIG. 1.

FIG. 1 is a schematic cross-sectional view of a conventional perpendicular magnetic recording apparatus. Generally, a perpendicular magnetic recording apparatus includes a perpendicular magnetic recording medium and a magnetic head.

Referring to FIG. 1A, the conventional magnetic recording medium includes a soft magnetic underlayer 11, a recording layer 12, and a protective layer 13 sequentially formed on a substrate 10. An intermediate layer may be interposed between the soft magnetic underlayer 11 and the recording layer 12 to prevent exchange coupling between the layers. A magnetic head 15 is located above the perpendicular magnetic recording medium and includes a main pole and a return pole. The soft magnetic underlayer 11 has been introduced to make data writing easy by effectively magnetizing a region A of the recording layer 12.

In detail, the magnetic head applies magnetic flux M on the recording layer 12 and magnetizes the recording layer 12 to record information. For example, to record information on the recording layer 12, magnetic flux from the main pole magnetizes the recording layer 12 by a bit region unit, flows along the soft magnetic underlayer 11 under the recording layer 12, and is then collected to the return pole. The soft magnetic underlayer 11 provides a magnetic flux path from the main pole through the recording layer 12 to the return pole, so that the recording layer 12 is more effectively magnetized.

The soft magnetic underlayer 11 may be formed as a multilayer, as shown in FIG. 1B. FIG. 1B is a view illustrating the structure of the conventional soft magnetic underlayer. The soft magnetic underlayer 11, which is formed on a substrate 101, may include a seed layer 102 and a buffer layer 103. An antiferromagnetic or antiferromagnetic coupling (“AFM”) layer 104 and a soft magnetic layer 105 may be sequentially formed on the seed and buffer layers. Also, a recording layer 106 may be formed on the soft magnetic layer 105. An intermediate layer (not shown) may optionally be interposed between the soft magnetic layer 105 and the recording layer 106. In one example of the soft magnetic underlayer 11, the seed layer 102 may be formed of Ta, the buffer layer 103 may be formed of NiFeCr, the AFM layer 104 may be formed of IrMn, the soft magnetic layer 105 may be formed of CoNbZr, FeCoB or NiFeNb, and the intermediate layer may be formed of Ru. The substrate 101 may be formed of glass.

The soft magnetic underlayer comprised of multiple layers is formed by a sputtering process, and may require high temperature heat treatment depending on a structure and a composition of the recording layer. A heat treatment performed at a temperature of 500° C. or above causes diffusion of transition metals such as Mn, Fe, Co, and Ni from one layer to another layer of the soft magnetic underlayer. Such diffusion causes deterioration of a magnetic characteristic such as exchange coupling force and thus reduces a recording characteristic of perpendicular magnetic recording media. Therefore, a solution to prevent diffusion of transition metals of a soft magnetic underlayer of a magnetic recording medium during a high temperature process is highly required.

### SUMMARY OF THE INVENTION

The present invention provides perpendicular magnetic recording media including a soft magnetic underlayer, which comprises a layer which blocks diffusion of components between layers of the soft magnetic during a high temperature heat treatment process.

According to an aspect of the present invention, there is provided perpendicular magnetic recording media including a soft magnetic underlayer and a recording layer formed on the soft magnetic underlayer, the soft magnetic underlayer including: an underlayer; a diffusion barrier layer formed on the underlayer; an AFM (antiferromagnetic or antiferromagnetic coupling) layer formed on the diffusion barrier layer; and a soft magnetic layer formed on the AFM layer.

According to one aspect of the present invention, there is provided perpendicular magnetic recording media including a magnetic recording layer; a soft magnetic underlayer; and a substrate, wherein the soft magnetic underlayer includes a layer formed of a soft magnetic material (“soft magnetic layer”); an anti-ferromagnetic (“AMF”) layer; an underlayer formed of a transition metal or a transition metal alloy (“transition metal underlayer”); and a layer (“barrier layer”) formed of a non-magnetic, non-transition metal material, which is interposed between the AMF layer and the transition metal underlayer.

The underlayer may include a seed layer and may further include a buffer layer formed on the seed layer.

The media may further include an intermediate magnetic layer formed between the diffusion barrier layer and the AFM layer.

The diffusion barrier layer is formed of a non-magnetic, non-transition metal material that does not adversely affect growth of its neighboring layer. In one embodiment, the diffusion barrier layer may be formed of Ru.

The AFM layer may be formed of Mn compound.

The soft magnetic layer may be formed of Co alloy including CoFeB, CoZrNb, and CoTaZr, or CoFe alloy including, for example, Co₉₀Fe₁₀ and Co₃₅Fe₆₅.

The seed layer may be formed of one of Ta and Ta alloy.

The buffer layer may be formed of one of Ta/Ru compound and NiFeCr.

The intermediate magnetic layer may be formed of CoFeB.

### BRIEF DESCRIPTION OF THE DRAWINGS

The above and other features and advantages of the present invention will become more apparent by describing in detail exemplary embodiments thereof with reference to the attached drawings in which:

FIG. 1A is a schematic view of a conventional perpendicular magnetic recording apparatus;

FIG. 1B is a view of a conventional soft magnetic underlayer;

FIG. 2 is a view of the structure of a perpendicular magnetic recording medium including a soft magnetic underlayer with a diffusion barrier layer;

FIG. 3A is a graph illustrating an M-H characteristic of a perpendicular magnetic recording medium without a diffusion barrier layer in an as-depo state;

FIG. 3B is a graph illustrating an M-H characteristic of a perpendicular magnetic recording medium including a soft magnetic underlayer with a diffusion barrier layer in an as-depo state according to an embodiment of the present invention;

FIG. 4A is a graph illustrating an M-H characteristic when a perpendicular magnetic recording medium without a diffusion barrier layer is formed and then heated at a temperature of 600° C. for 32.5 seconds;

FIG. 4B is a graph illustrating an M-H characteristic when a perpendicular magnetic recording medium including a soft magnetic underlayer with a diffusion barrier layer according to an embodiment of the present invention is formed and then heated at a temperature of 600° C. for 32.5 seconds;

FIG. 5A is a graph illustrating results of component distribution as measured by an SIMS (Secondary-ion mass spectroscopy) after a perpendicular magnetic recording medium without a diffusion barrier layer is formed and then heat-treated at a temperature of 600° C.; and

FIG. 5B is a graph illustrating results of component distribution as measured by an SIMS after a perpendicular magnetic recording medium including a soft magnetic underlayer with a diffusion barrier layer according to an embodiment of the present invention is formed and then heat-treated at a temperature of 600° C.

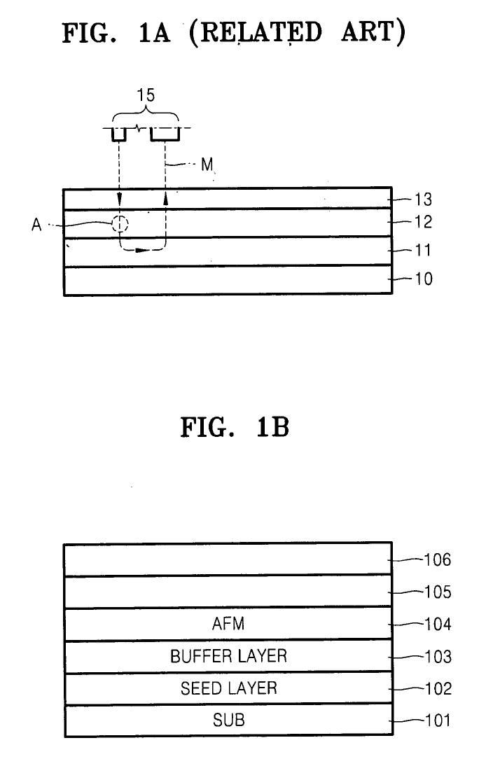

### DETAILED DESCRIPTION OF THE INVENTION

The present invention will now be described more fully with reference to the accompanying drawings, in which exemplary embodiments of the invention are shown. In the drawings, the thicknesses of layers and regions are exaggerated for clarity.

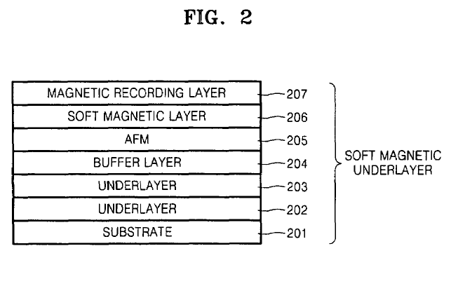

FIG. 2 is a view of the structure of a perpendicular magnetic recording medium including a soft magnetic underlayer with a diffusion barrier layer.

Referring to FIG. 2, a perpendicular magnetic recording medium includes a soft magnetic underlayer according to an embodiment of the present invention. The soft magnetic underlayer includes underlayers 202 and 203, a diffusion barrier layer 204, an AFM layer 205, and a soft magnetic layer 206 sequentially formed or a substrate 201. A recording layer 207 is formed on the soft magnetic layer 206, and an intermediate layer (not shown) may be interposed between the soft magnetic layer 206 and the recording layer 207 to improve a crystal alignment characteristic and a magnetic characteristic of the recording layer. Also, the perpendicular magnetic recording medium may further include a protective layer and/or a lubrication layer (not shown) formed on the recording layer 207. The underlayers 202 and 203 may be a seed layer and a buffer layer, respectively.

According to another embodiment, the perpendicular magnetic recording medium includes a soft magnetic underlayer which includes a soft magnetic layer, an AMF layer, a seed layer (or seed layers), a buffer layer (or growth layers), which sequentially formed on a substrate. A magnetic recording layer is formed on the buffer layer. In this embodiment, a barrier layer is interposed between the AMF layer and the seed layer. Also, the perpendicular magnetic recording medium may further include a protective layer and/or a lubrication layer formed on the recording layer

Materials which may be used for each layer according to an embodiment of the present invention will be described in detail below. A substrate used for general perpendicular magnetic recording media may be used for the substrate 201 without limitation. The substrate 201 may be formed of glass, for example. The seed layer 202 and the buffer layer 203 are designed for promoting the growth of a magnetic layer. The seed layer 202 may be formed of one of Ta and Ta alloy, and the buffer layer 203 may be formed of one of Ta/Ru compound and NiFeCr.

The diffusion barrier layer 204 prevents a transition metal (e.g., Mn, Fe, Co, or Ni) constituting the buffer layer 203 or the AFM layer 205 from diffusing from one layer to other neighboring layer(s) and may be formed of a non-magnetic, non-transition metal material that does not have an adverse effect on the growth of the AFM layer 205. The diffusion barrier layer 204 may be formed of Ru, Ru alloy or composite of Ru and other material(RuO) in a thickness ranging from several nm to several tens nm. The diffusion barrier layer 204 interposed between the buffer layer 203 and the AFM layer 205 prevents migration of a transition metal such as Mn, Fe, Co, and Ni constituting the buffer layer 203 or the AFM layer 205 from one layer to other neighboring layer(s) during a heat treatment performed at a high temperature of about 500° C. or higher. When components of these layers migrate between layers, a magnetic hysteresis curve changes, resulting in deterioration of recording characteristics of perpendicular magnetic recording media. Therefore, it is possible to maintain the recording characteristic of perpendicular magnetic recording media even during a high temperature heat treatment process by providing the diffusion barrier layer 204.

The AFM layer 205 determines a magnetization direction of the soft magnetic layer 206 formed thereon, and the thickness of the AFM layer may change exchange coupling force. The AFM layer 205may be formed of Mn compound such as IrMn in a thickness ranging from several nm to several tens nm. The soft magnetic layer may be formed of various magnetic materials. For example, it may be formed of Co alloy including CoFeB, CoZrNb, and CoTaZr, or CoFe alloy including Co₉₀Fe₁₀ and Co₃₅Fe₆₅. An intermediate magnetic layer (not shown) may be further formed between the AFM layer 205 and the soft magnetic layer 206. The intermediate layer, which may be made of CoFeB in a thickness of several nm, may reinforce a fixing of a magnetization direction of the soft magnetic layer 206, provided by the AFM layer 205.

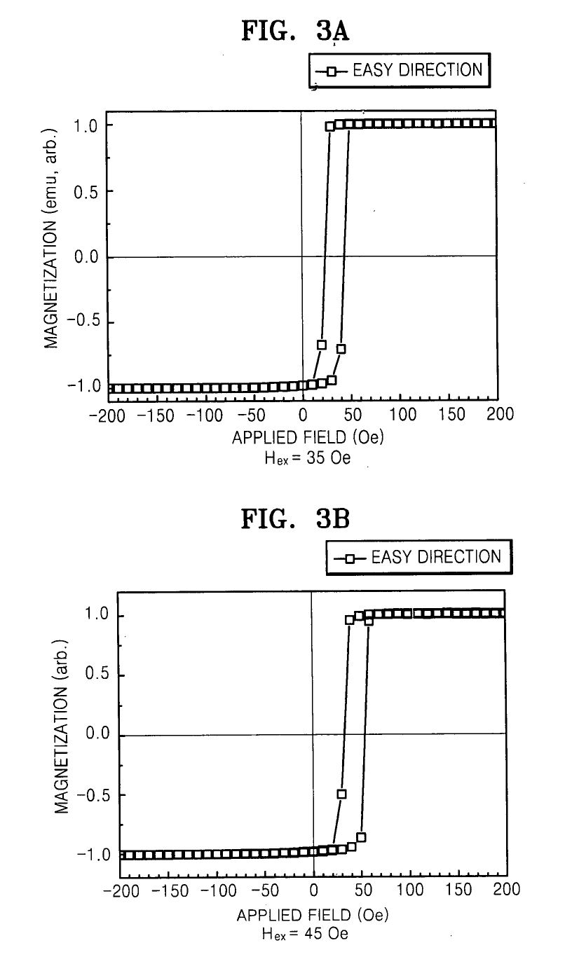

FIG. 3A is a graph illustrating an M-H characteristic of a perpendicular magnetic recording medium without a diffusion barrier layer, in an as-depo state. A test sample of the perpendicular magnetic recording medium (for comparison) has been prepared by forming a Ta seed layer in a thickness of about 5 nm on a glass substrate and forming a NiFeCr buffer layer in a thickness of about 5 nm on the Ta seed layer. Also, an IrMn AFM layer is formed in a thickness of 10 nm on the NiFeCr buffer layer, and a CoFeB intermediate magnetic layer is formed in a thickness of about 2 nm on the IrMn AFM layer. Also, a CoZrNb soft magnetic layer is formed in a thickness of about 40 nm on the CoFeB intermediate magnetic layer, and a Ru layer is formed in a thickness of about 20 nm on the CoZrNb soft magnetic layer.

FIG. 3B is a graph illustrating an M-H characteristic of perpendicular magnetic recording media including a soft magnetic underlayer with a diffusion barrier layer, in an as-depo state, according to an embodiment of the present invention. A test sample of the perpendicular magnetic recording medium has been prepared by forming a Ta seed layer in a thickness of about 5 nm on a glass substrate and a NiFeCr buffer layer in a thickness of about 5 nm on the Ta seed layer. A Ru diffusion barrier layer is formed in a thickness of 10 nm on the NiFeCr buffer layer, a CoFeB intermediate magnetic layer (2 nm thickness) and an IrMn AFM layer (10 nm thickness) are sequentially formed on the diffusion barrier layer. Also, a CoZrNb soft magnetic layer is formed in a thickness of about 40 nm on the IrMn AFM layer, and a Ru layer is formed in a thickness of about 20 nm on the CoZrNb soft magnetic layer. Therefore, the perpendicular magnetic recording medium of FIG. 3B contains an additional layer (made of Ru) interposed between the buffer layer and the AFM layer.

Referring to FIGS. 3A and 3B, exchange coupling force (Hex) of FIG. 3A is about 35 Oe, and exchange coupling force (Hex) of FIG. 3B is about 45 Oe. When heat treatment is not performed, a structure where a diffusion barrier layer is inserted shows a greater exchange coupling force.

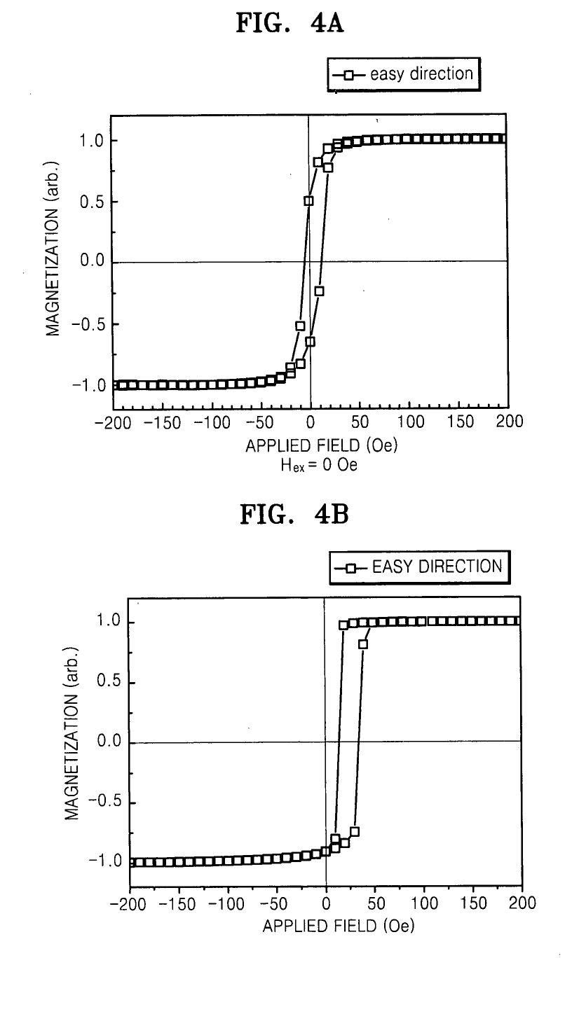

FIG. 4A is a graph illustrating an M-H characteristic when perpendicular magnetic recording media without a diffusion barrier layer is formed and then heated at a temperature of 600° C. for 32.5 seconds. Here, a test sample used for a measurement target is the test sample used in FIG. 3A, and heat treatment has been performed in a surrounding atmosphere of 600° C. for 32.5 seconds.

FIG. 4B is a graph illustrating an M-H characteristic when a perpendicular magnetic recording medium including a soft magnetic underlayer with a diffusion barrier layer according to an embodiment of the present invention is heat-treated. Here, a test sample used for a measurement target is the one used in FIG. 4B, and heat treatment has been performed at a temperature of 600° C. for 32.5 seconds.

Referring to FIGS. 4A and 4B, when the diffusion barrier layer is not present, exchange coupling force drastically reduces and reaches almost 0 Oe. On the other hand, when heat treatment is performed on the structure where the diffusion barrier layer is inserted, exchange coupling force becomes 24 Oe, resulting in reduction of the exchange coupling force compared to an as-depo state, which is a pre-heat-treatment state, but the exchange coupling force improves compared to the case where the diffusion barrier layer is not inserted.

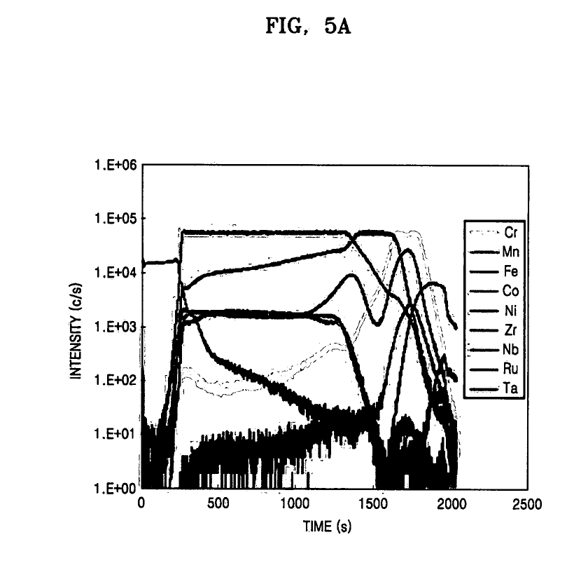

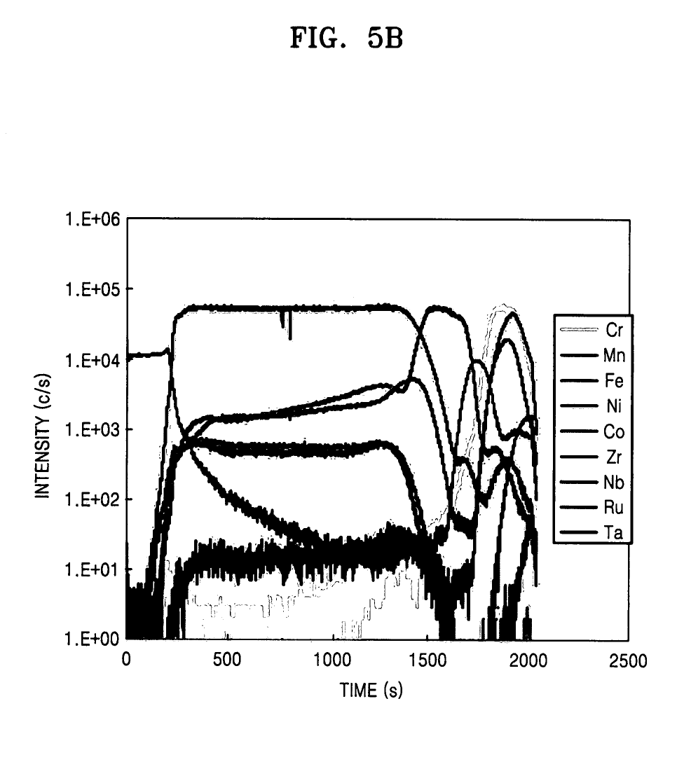

FIG. 5A is a graph illustrating results of component distribution as measured by a secondary-ion mass spectroscopy (SIMS) after a perpendicular magnetic recording medium without a diffusion barrier layer is formed and then heat-treated at an ambient temperature of 600° C. The composition distribution has been measured for the test sample of FIG. 4A.

Referring to FIG. 5A, elements actively migrate throughout the test sample as the sample is heat-treated, and, particularly, the highest peak of Mn at 1500 s of a horizontal axis indicates that Mn migrates from one layer to other layer(s).

FIG. 5B is a graph illustrating the composition distribution as measured by an SIMS after a perpendicular magnetic recording medium including a soft magnetic underlayer with a diffusion barrier layer according to an embodiment of the present invention is formed and then heat-treated at a temperature of 600° C. The test sample is identical to the one used in the test of FIG. 4B.

FIG. 5B shows that diffusion of elements drastically reduces, compared to the results of FIG. 5A. Particularly, the distribution peak of Mn, which indicates no significant migration from one layer to another layers, is clearly distinguished from the distribution illustrated in FIG. 5A. Other elements such as Fe, Co, and Ni also show low migrations. FIG. 5A and FIG. 5B show that the diffusion of Mn and Cr of the recording medium with a diffusion barrier layer have reduced nearly up to 1/10 compared to the recording medium without a diffusion barrier layer. The presence of the diffusion barrier layer effectively prevents diffusion of metals of the magnetic layers during heat treatments, attributing to increased thermal stability of the magnetic layers.

According to the present invention, following effects are provided.

First, the present invention can prevent diffusion of transition metals constituting an AFM layer or an underlayer between layers during a heat treatment process and thus prevent deterioration of recording characteristics of recording media.

Second, a perpendicular magnetic recording medium having excellent thermal stability is provided by inserting a diffusion barrier layer between layers of the medium, so that it is possible to perform heat treatments at an elevated temperature during a manufacturing process, and the perpendicular magnetic recording media can be stably used under higher temperature environments.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A perpendicular magnetic recording medium comprising a magnetic recording layer, a soft magnetic underlayer, and a substrate, wherein the soft magnetic underlayer comprises
a layer formed of a soft magnetic material (“soft magnetic layer”);
an anti-ferromagnetic (“AMF”) layer;
an underlayer formed of a transition metal or a transition metal alloy (“transition metal underlayer”); and
a layer (“barrier layer”) formed of a non-magnetic, non-transition metal material, which is interposed between the AMF layer and the transition metal underlayer.

2. The medium of claim 1, wherein the transition metal underlayer comprises a seed layer.

3. The medium of claim 1, wherein the transition metal underlayer comprises a seed layer and a buffer layer formed on the seed layer.

4. The medium of claim 1, further comprising an intermediate magnetic layer formed between the barrier layer and the AFM layer.

5. The medium of claim 1, wherein the barrier layer is formed of Ru, RuO or a Ru alloy.

6. The medium of claim 1, wherein the AFM layer is formed of a Mn compound.

7. The medium of claim 1, wherein the soft magnetic layer is formed of a Co alloy or a CoFe alloy.

8. The medium of claim 2, wherein the seed layer is formed of one of Ta and Ta alloy.

9. The medium of claim 3, wherein the buffer layer is formed of one of a Ta/Ru compound and NiFeCr.

10. The medium of claim 4, wherein the intermediate magnetic layer is formed of CoFeB.

11. The medium of claim 3, wherein the seed layer is formed of one of Ta and Ta alloy.

12. The medium of claim 7, wherein the Co alloy is one selected from the group consisting of CoFeB, CoZrNb, and CoTaZr.

13. The medium of claim 7, wherein the CoFe alloy is one selected from the group consisting of Co₉₀Fe₁₀ and Co₃₅Fe₆₅.
